(19) United States
(12) Patent Application Publication
(10) Pub. No.: US 2008/0267311 A1
(43) Pub. Date: Oct. 30, 2008

(54) RADIO COMMUNICATION METHOD, RADIO TRANSMISSION APPARATUS AND RECEIVING APPARATUS

(76) Inventor: Ren SAKATA, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/049,708

(22) Filed: Mar. 17, 2008

(30) Foreign Application Priority Data
Apr. 26, 2007 (JP) 2007-117589

(51) Int. Cl. H04B 7/02

(52) U.S. Cl. 375/267

(57) ABSTRACT

A radio communication method including, generating a first transmit RF signal and a second transmit RF signal from a data signal to be transmitted, wherein the first transmit RF signal and the second transmit RF signal being subjected to a code spread by a first spreading code and a second spreading code, respectively forming a symmetric power spectrum in the frequency domain, transmitting the first transmit RF signal and the second transmit RF signal from a transmit antenna at a different time, receiving the first transmit RF signal and the second transmit RF signal to generate a first received RF signal and a second received RF signal, and reproducing the data signal from the first received RF signal and the second received RF signal.

### CROSS-REFERENCE TO RELATED APPLICATIONS

This application is based upon and claims the benefit of priority from prior Japanese Patent Application No. 2007-117589, filed Apr. 26, 2007, the entire contents of which are incorporated herein by reference.

### BACKGROUND OF THE INVENTION

1. Field of the Invention

The present invention relates to a radio communication method, a radio transmission apparatus and a radio receiving apparatus using time and frequency diversity.

2. Description of the Related Art

Conventionally, some diversity techniques have been put into practice in the field of radio communication. A diversity is a technique to transmit and receive a plurality of signals by using a plurality of radio communication resources and improve reception quality by choosing a received signal which is in good communication status at the receiving end, or by combining a plurality of received signals. As a type of diversity, there are a time diversity, in which (a) identical signals are transmitted twice at different times, (b) a frequency diversity, in which identical signals are transmitted by two different frequencies, (c) an antenna diversity, in which the transmitted signals are received by two antennas arranged at different locations, and (d) a path diversity, in which a plurality of delayed waves arriving at the antennas via different propagation paths (channels) are combined.

NTT DoCoMo, KDDI, Mitsubishi Electric, NEC, Panasonic and Sharp, “Repetition of ACK/NACK in E-UTRA Uplink”, R1-070101, 3GPP TSG-RAN WG1 Meeting, #47bis (2007.01), (Document 1), disclose a technique combining time diversity and frequency diversity. In Document 1, as shown in FIG. 1, two transmit RF signals which have different center frequencies are generated from an identical data signal (ACK/NACK signal in Document 1) and transmitted at different times. Since the two transmit RF signals have different center frequencies, even in the case where they are transmitted via a channel having frequency selectivity likewise a multipath channel, there will be less possibility that both transmit RF signals will concurrently pass through a frequency band with large power attenuation (frequency diversity). In addition, because the transmitting time of the two transmit RF signals is different, the peak power can be prevented from increasing, which is caused by the transmit RF signals becoming multicarrier signals, and the two transmit RF signals can also be prevented from being transmitted concurrently during a time zone with large power attenuation (time diversity).

Meanwhile, NTT DoCoMo, Fujitsu, KDDI, Mitsubishi Electric, Sharp, “CDMA-Based Multiplexing Method for Multiple ACK/NACK and CQI in E-UTRA Uplink”, R1-071649, 3GPP TSG-RAN WG1 Meeting, #48bis (2007.03) (Document 2), disclose a method of dividing a data signal in two, which data signal is code-spread using an identical spreading code, and converting each of them into transmit RF signals which have different center frequencies, then transmitting them. By varying the center frequency, the possibility of the total data signal before the division to pass through a frequency band with large power attenuation reduces. This effect is similar to that of the frequency diversity explained above. Further, by spreading the data signal by a spreading code, a receiver is able to obtain a despread gain, and becomes capable of reception even in the case of a larger power attenuation. This transmit RF signal can be generated by, first, converting an identical spreading code into two frequencies having different frequencies, and, subsequently, by spreading a part of and the remainder of the data signals using each of the frequencies. Furthermore, it is also possible to perform Code Division Multiplexing (CDM) by varying the spreading codes among the transmitters, or among the data signals. Various spreading codes are known to be used for the above purpose. However, Document 2 uses a sequence which is referred to as a CAZAC (Constant Amplitude and Zero Auto-Correlation) sequence, which has a constant amplitude, and in which an autocorrelation becomes “0” in the case where a time difference of the sequence is other than “0”.

In the method described in Document 1, frequency conversion must be performed twice in order to transmit the same data signal in different frequencies and at different times. In the frequency conversion, for example, it is necessary to carry out the following processes; (a) generate sinusoidal signals, (b) multiply a transmit baseband signal obtained by modulating the data signal by the sinusoidal signal, and (c) filter the multiplied signal. In the method of Document 1, these processes are performed twice, by using sinusoidal signals having different frequencies.

In the method described in Document 2, frequency conversion must also be performed twice in order to transmit the code spread data signal in different frequencies and at different times. Even if the spreading code of two frequencies is prepared in advance of using the method of spreading the transmit data signal, it is necessary to perform the frequency conversion twice to generate the spreading code of two frequencies.

Generally, the process of this type of frequency conversion requires an increase in calculation amount in accordance with the signal length of the data signal. In the case of a digital signal process, the number of times of multiplication is required in proportion to the signal length. Accordingly, it is not favorable for mobile appliances requiring downsizing, lightness and low power consumption to carry out the frequency conversion process twice, since this leads to increased power consumption and circuit size.

### BRIEF SUMMARY OF THE INVENTION

According to one aspect of the present invention, there is provided a radio communication method including, generating a first transmit RF signal and a second transmit RF signal from a data signal to be transmitted, wherein the first transmit RF signal and the second transmit RF signal being subjected to a code spread by a first spreading code and a second spreading code, respectively forming a symmetric power spectrum in the frequency domain, transmitting the first transmit RF signal and the second transmit RF signal from a transmit antenna at a different time, receiving the first transmit RF signal and the second transmit RF signal to generate a first received RF signal and a second received RF signal, and reproducing the data signal from the first received RF signal and the second received RF signal.

### BRIEF DESCRIPTION OF THE SEVERAL VIEWS OF THE DRAWING

FIG. 1 is a schematic view of a radio communication system including a base station and terminals.

FIG. 2 is a block diagram illustrating a transmission and reception system provided in the base station and the terminals.

FIG. 3 illustrates an example of frequency relations between transmit and received baseband signals and transmit and received RF signals.

FIG. 4 illustrates another example of frequency relations between the transmit and received baseband signals and the transmit and received RF signals.

FIG. 5 illustrates an example of a channel response.

FIG. 6 illustrates an example of a frequency arrangement of subbands in an FDMA communication.

FIG. 7 illustrates an example of a frequency arrangement of subbands and subcarriers in an OFDMA communication.

FIG. 8 illustrates relations between a plurality of transmit RF signals and a plurality of received RF signals.

FIG. 9 is a block diagram illustrating a transmitter according to a first embodiment.

FIG. 10 is a diagram explaining the generation of first and second spreading codes according to the first embodiment.

FIG. 11 is a block diagram illustrating a receiver according to the first embodiment.

FIG. 12 is a diagram explaining a complex conjugate calculation used in a computing unit in FIGS. 9 and 11.

FIG. 13 illustrates a frequency characteristic for each unit in the first embodiment.

FIG. 14 is a block diagram illustrating a transmitter according to a second embodiment.

FIG. 15 is a diagram explaining the generation of first and second spreading codes according to the second embodiment.

FIG. 16 is a block diagram illustrating a receiver according to the second embodiment.

FIG. 17 illustrates a frequency characteristic for each unit in the second embodiment.

FIG. 18 illustrates an example of a frequency arrangement of the first and second transmit RF signals.

FIG. 19 is a block diagram illustrating a specific example of a transmission frequency converter in FIG. 14.

FIG. 20 is a block diagram illustrating a transmitter according to a third embodiment.

FIG. 21 is a block diagram illustrating a transmitter according to a fourth embodiment.

FIG. 22 is a block diagram illustrating a receiver according to a fifth embodiment.

FIG. 23 is a block diagram illustrating a transmitter according to a sixth embodiment.

FIG. 24 is a block diagram illustrating a receiver according to a sixth embodiment.

FIG. 25 is a block diagram illustrating a transmitter according to a seventh embodiment.

### DETAILED DESCRIPTION OF THE INVENTION

Embodiments of the present invention will be explained in detail with reference to the drawings as follows.

(Radio Communication System)

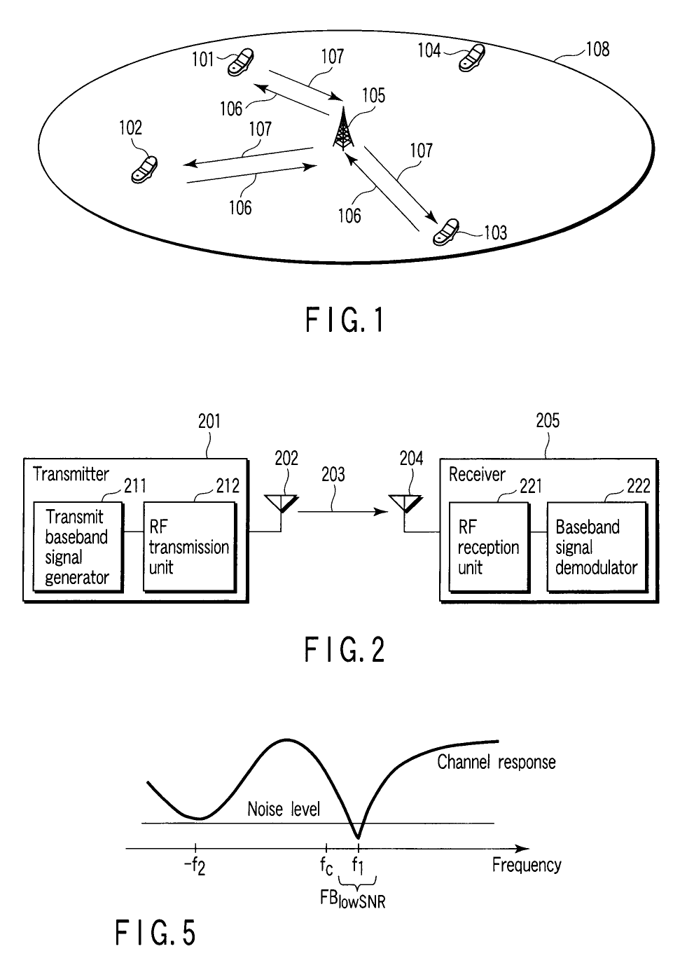

As illustrated in FIG. 1, a radio communication system according to a first embodiment of the present invention comprises a plurality of mobile terminals, such as terminals 101 to 104, and a base station 105. Terminals 101 to 104 are located within a cover area 108 of the base station 105. Here, there are four terminals 101 to 104 and one base station 105. However, this is not restricted. Therefore, for instance, there may be one terminal and a plurality of base stations. A downlink 106 is used when communicating from the base station 105 to the terminals 101 to 104, and an uplink 107 is used when communicating from the terminals 101 to 104 to the base station 105.

As illustrated in FIG. 2, in the downlink 106 process, the transmit RF signal is transmitted via a transmit antenna 202 from a transmitter 201, which is provided on the base station 105. In the transmitter 201, a transmit baseband signal generator 211 generates a transmit baseband signal from a data signal. The transmit baseband signal is input to an RF transmission unit 212 and subject to an RF process. The RF process carried out by the RF transmission unit 212 includes a process of upconverting the transmit baseband signal into an RF frequency, and a process of subjecting such upconverted signal to power amplification. In some cases, the RF process further includes a filter process. The RF transmit signal is generated by such RF process carried out by the RF transmission unit 212.

The transmit RF signal arrives at a receive antenna 204, which is provided on the terminals 101 to 104, via a channel (propagation path) 203, and a received RF signal is output from the receive antenna 204. The received RF signal is input to the receiver 205, and is subjected to the RF process by an RF reception unit 221. The RF process carried out by the RF reception unit 221 includes a process of amplifying the received RF signal and a process of downconverting such amplified received RF signal into a baseband frequency. In some cases, the RF process further includes a filter process. A received baseband signal is generated by this type of process carried out by the RF reception unit. The received baseband signal is further demodulated by a baseband signal demodulator 222, thereby reproducing a transmit data signal.

Meanwhile, in the process of the uplink 107, a signal is transmitted from the transmitter 201, which is provided on the terminals 101 to 104, via the transmit antenna 202. The signal arrives at the receive antenna 204, which is provided on the base station 105, via the channel 203 and is input to the receiver 205. The processes carried out by the transmitter 201 and the receiver 205 in the uplink 107 are the same as those carried out in the downlink 106.

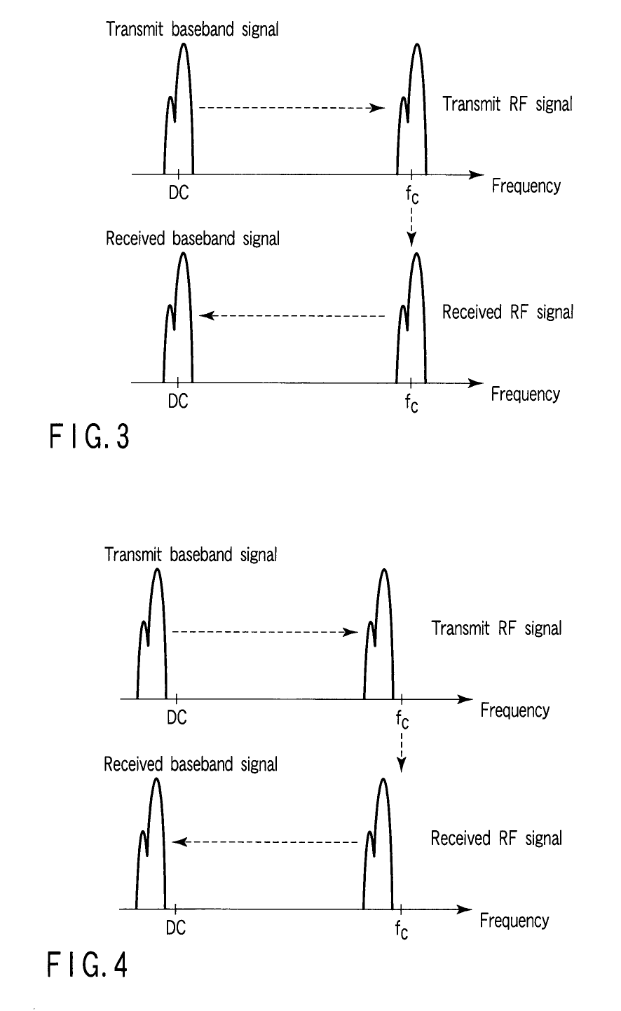

Frequency relations between the transmit and received baseband signals and the transmit and received RF signals may be either one of FIGS. 3 and 4. According to FIG. 3, the center frequency of the transmit baseband signal and the received baseband signal is DC, and the center frequency of the transmit RF signal and received RF signal is a carrier frequency f_{c}. In contrast, in FIG. 4, the center frequency of the transmit baseband signal and received baseband signal is not DC, and the carrier frequency f_{c} is not the center frequency of the transmit RF signal and the received RF signal.

FIG. 5 shows an example of a frequency characteristic of an impulse response (referred to as a channel response) possessed by the channel 203. Generally, the channel 203 is mostly a multipath channel. In the multipath channel, frequencies which strengthen, or, instead, weaken each other's signal power occur between each of the channels. In the example of FIG. 5, significant power reduction occurs in the frequency band near frequencies f₁ and −f₂. Such characteristic of the multipath channel is called frequency selectivity.

In a frequency band where such frequency selectivity causes power reduction, a signal becomes relatively susceptible to noise when the received power becomes low. Therefore, the signal to noise ratio (SNR) deteriorates. Here, a frequency band which undergoes reduction in received power is referred to as FB_{lowSNR}. In the case where the transmit RF signal is a narrow band signal, the possibility of receiving error increases when transmitting the signal by the frequency band FB_{lowSNR}. Generally, by widening the bandwidth of the transmit RF signal, the entire bandwidth of the transmit RF signal can be prevented from merging into the frequency band FB_{lowSNR}, thereby, averting receiving error.

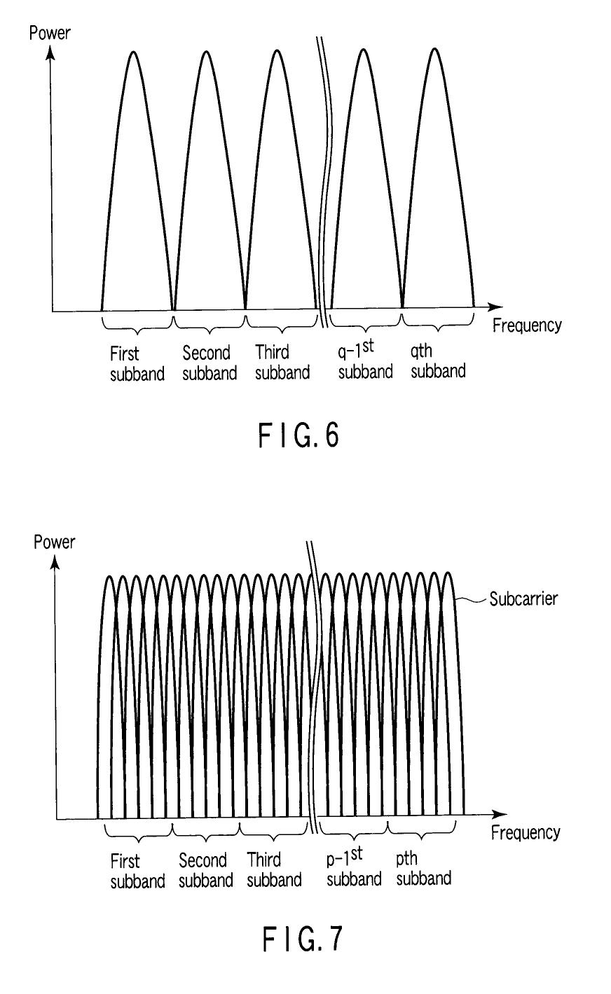

The frequency bandwidth the transmitter 201 uses for transmission, or the transmittable frequency bandwidth, is assumed as being divided into q pieces of subbands as illustrated in FIG. 6. Here, the subbands are referred to as the first subband to the qth subband in the order of frequency from low to high. The transmitter 201 is assumed as transmitting a signal using one subband. It depends on the instruction from the transmitter 201 or receiver 205 as to which subband will be used upon transmission. By forming a plurality of subbands in this manner, a frequency division multiplexing (FDM) communication in which a plurality of transmit RF signals are transmitted simultaneously can be realized.

Meanwhile, the receiver 205 is assumed to receive the signal transmitted using any one of the subbands from the transmitter 201. The number of subbands and the frequency bandwidth of a subband need not necessarily be fixed. For example, the number of subbands and the subband frequency bandwidth may be varied in accordance with the transmission rate required upon transmission and the number of transmitters and receivers communicating simultaneously.

As a particular case of FDM communication, there is an Orthogonal Frequency Division Multiple Access (OFDMA) communication. FIG. 7 shows the usage of frequency in the OFDMA communication. Likewise FIG. 6, the frequency band to be used is divided into p pieces of subbands. However, it is different from FIG. 6 in that one subband includes a plurality of subcarriers. Each of the subcarriers is arranged so that they are mutually orthogonal in the frequency domain. In other words, each of the subcarriers is arranged so as not to interfere with the other subcarriers. In the present embodiment, even such OFDMA communication is applicable by considering a plurality of subcarriers as one subband.

According to the present embodiment, a plurality of transmit RF signals are generated from a code-spread data signal in the transmitter 201. These transmit RF signals are transmitted at different times via the transmit antenna 202 and the channel 203. The plurality of transmit RF signals transmitted via the channel 203 are received by the receiver via the receive antenna 204.

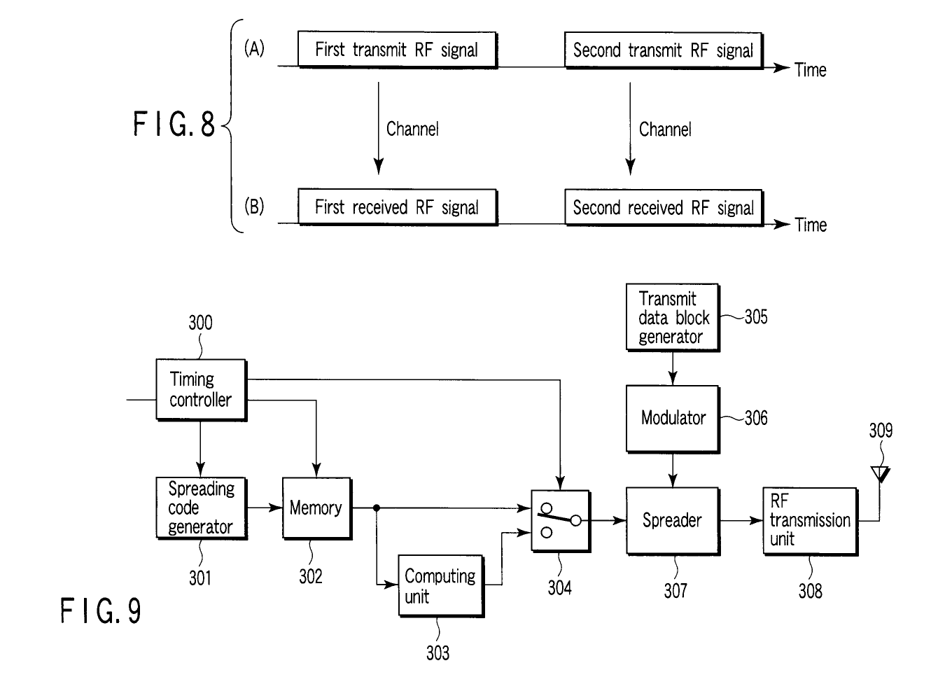

According to the example of FIG. 8(A), two transmit RF signals (first and second transmit RF signals) are transmitted at different transmitting times from the transmitter 201. In other words, first, the first transmit RF signal is transmitted, then, the second transmit RF signal is transmitted. The first transmit RF signal and the second transmit RF signal are received by the receiver 205 via the channel 203 as illustrated in FIG. 8(B), thereby obtaining a first received RF signal and a second received RF signal.

Here, when the transmitting time is different, it means that the time to start transmission or the time to end transmission of the first transmit RF signal and the second transmit RF signal is different.

Accordingly, the first transmit RF signal and the second transmit RF signal may partially overlap, or may not overlap at all on the time domain. In a situation using FDM communication, the first transmit RF signal and the second transmit RF signal each use a different subband so that they are transmitted in a state where each transmit RF signal partially overlaps each other. In this case, either the transmission starting time or the transmission ending time needs to be different.

In the present embodiment, in order to realize frequency diversity, the first transmit RF signal and the second transmit RF signal are used and are transmitted at different times. The transmitted first transmit RF signal and the transmitted second transmit RF signal are generated from a part of a transmit baseband signal which is obtained by modulating and subjecting the data signal to a code spread.

In this manner, by transmitting the transmit RF signals twice from the transmitter 201 and by receiving the two transmit RF signals at the receiver 205, it is possible to increase the amount of transmissible and receivable data signals. For example, by using the increased amount of transmissible and receivable data signals for redundant bits to correct errors, the possibility of a failure in reception can be reduced. At the same time, by transmitting the baseband signal subjected to code spread, a gain due to despreading can be obtained at the receiving end, thereby further reducing the possibility of failure in reception.

### TRANSMITTER OF THE FIRST EMBODIMENT

The transmitter 201 according to the first embodiment will be explained with reference to FIG. 9. As illustrated in FIG. 9, the transmitter 201 comprises a timing controller 300, a spreading code generator 301, a memory 302, a computing unit 303, a signal selector 304, a transmit data block generator 305, a modulator 306 and an RF transmission unit 308. The RF transmission unit 308 corresponds to the RF transmission unit 212 in FIG. 2, and is connected to a transmit antenna 309, which corresponds to the transmit antenna 202 in FIG. 2. The spreading code generator 301, the memory 302, the computing unit 303, the signal selector 304, the transmit data block generator 305 and the modulator 306 correspond to the transmit baseband signal generator 211 in FIG. 2.

The transmit data block generator 305 generates a transmit data block (a data block to be transmitted, also referred hereinafter as transmit data signal) by cutting out data in constant length from the error-correcting coded data. The transmit data signal is, for example, ACK (Acknowledge)/NACK (Non-Acknowledge)/CQI (channel Quality Indicator) signals, though it is not restricted to these signals. The generated transmit data signal is input to the modulator 306 in accordance with the instruction from the timing controller 300.

The modulator 306 modulates the transmit data signal input from the transmit data block generator 305, thereby generating a transmit baseband signal (a first transmit baseband signal), which is a modulated signal. In the modulator 306, various digital modulation schemes which are known conventionally are used. Such modulation schemes are, for example, BPSK (Binary Phase Shift Keying), QPSK (Quadrature Phase Shift Keying), ASK (Amplitude Shift Keying), FSK (Frequency Shift Keying), 16QAM (16 Quadrature Amplitude Modulation), 64QAM, or OFDM (Orthogonal Frequency Division Multiplexing).

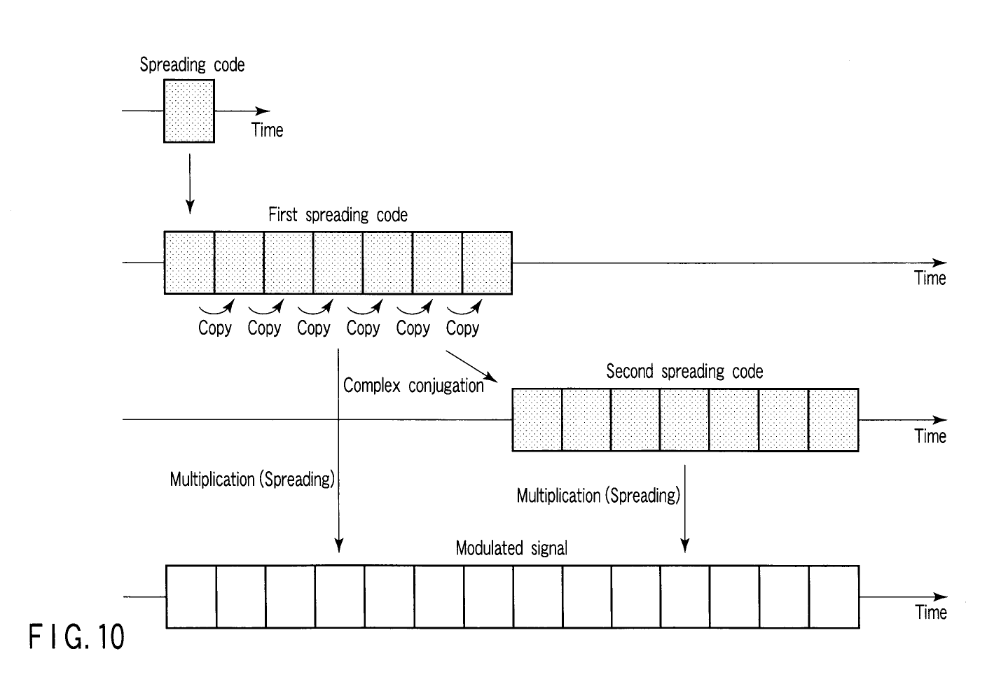

The spreading code generator 301, the memory 302, the computing unit 303 and a spreader 307 will be explained using FIG. 10. FIG. 10 illustrates the process up to generating the first transmit baseband signal which is the origin of a first transmit RF signal and the second transmit baseband signal which is the origin of a second transmit RF signal. The example of FIG. 10 shows the aspect of transmitting seven symbols each of the modulated signals by the first and the second transmit baseband signals. Each symbol is spread by a spreading code having a length of 12.

Firstly, the spreading code in a length of 12 is prepared by the spreading code generator 301, and is stored in the memory 302. The operation of reading out from the memory 302 is repeated seven times, i.e., the spreading code is copied seven times, thereby generating a first spreading code. A part of the modulated signal (seven symbols) output from the modulator 306 is multiplied by the first spreading code, thereby generating a code-spread first transmit baseband signal.

Meanwhile, the computing unit 303 performs, for example, a complex conjugate computation on the first spreading code, thereby generating a second spreading code. Another part of the modulated signal (seven symbols) output from the modulator 306 is multiplied by the second spreading code, thereby generating a code-spread second transmit baseband signal.

In other words, the spreading code obtained by the spreading code generator 301 is stored in the memory 302. The spreading code stored in the memory 302 can be read out as needed, and the contents stored in the memory 302 are kept until a new spreading code is input from the modulator 306. The first spreading code is generated by reading out the spreading code stored in the memory 302 repeatedly, for example, seven times, at a timing provided by the timing controller 300. The first spreading code is transmitted to the computing unit 303 and the signal selector 304.

The second spreading code is generated by performing a computation, which is predetermined between the transmitter 201 and the receiver 205, on the first spreading code read out from the memory 302. The computing unit 303 performs a computation, such as the complex conjugate computation mentioned above, which makes the first and second spreading codes form a symmetrical power spectrum in the frequency domain.

The first and second spreading codes generated in this manner are transmitted to the signal selector 304. The signal selector 304 selects either the first spreading code read out from the memory 302 or the second spreading code output from the computing unit 303 in accordance with the instruction from the timing controller 300, and inputs the selected spreading code to the spreader 307. In the spreader 307, the code-spread first transmit baseband signal is generated by multiplying a part of the modulated signal (seven symbols) output from the modulator 306 by the first spreading code, and the code-spread second transmit baseband signal is generated by multiplying another part of the modulated signal (seven symbols) output from the modulator 306 by the second spreading code.

In the RF transmission unit 308, the transmit baseband signal output from the spreader 307 is subjected to frequency conversion and converted into an RF frequency, thereby generating a transmit RF signal. In other words, in the RF transmission unit 308, a first transmit RF signal corresponding to the first transmit baseband signal is generated, and a second transmit RF signal corresponding to the second transmit baseband signal is generated. In the RF transmission unit 308, the first and second transmit RF signals are further subjected to power amplification and supplied to the transmit antenna 309. The first and second transmit RF signals output from the RF transmission unit 308 are transmitted as a radio wave by the transmit antenna 309.

The timing controller 300 controls the timing of each unit as follows. First of all, the timing controller 300 instructs the transmit data block generator 305 the timing to generate the transmit data block. In the present embodiment, since the first and second transmit RF signals are transmitted for one transmit data block, the timing controller 300 controls the output of the next transmit data block to wait until the transmission of the second transmit RF signal terminates so that the content of the memory 302 remains unchanged until the generation of the first and second transmit RF signals is terminated.

The timing controller 300 instructs the memory 302 to perform a read operation of the baseband signal stored therein, each time the first and second transmit RF signals are transmitted. Further, the timing controller 300 instructs the RF transmission signal selector 304 to select the first spreading code which is read out from the memory 302 when it is the transmitting time of the first transmit RF signal, and to select the second spreading code which is output from the computing unit 303 when it is the transmitting time of the second transmit RF signal.

### RECEIVER OF THE FIRST EMBODIMENT

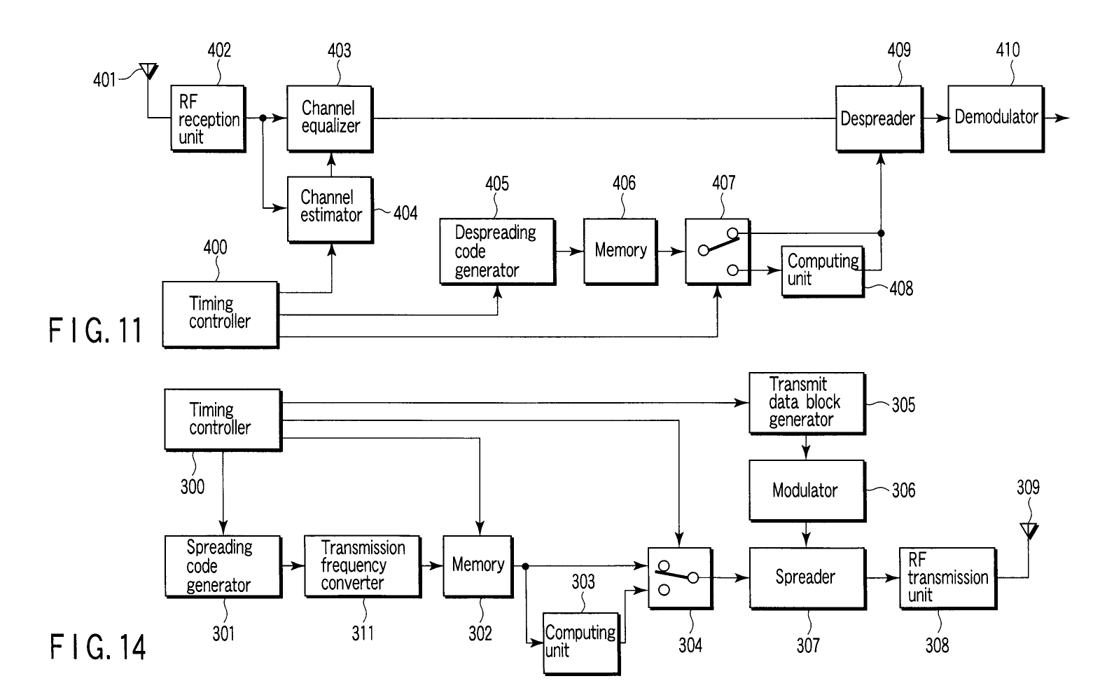

The receiver 205 according to the first embodiment will explained with reference to FIG. 11. As illustrated in FIG. 11, the receiver 205 comprises a timing controller 400, an RF reception unit 402, a channel equalizer 403, a channel estimator 404, a despreading code generator 405, a memory 406, a reception process selector 407, a computing unit 408, a computing unit 408, a despreader 409 and a demodulator 410. The RF reception unit 402 corresponds to the RF reception unit 221 in FIG. 2, which is connected to a receive antenna 401 corresponding to the receive antenna 204 in FIG. 2.

The receive antenna 401 receives the first and second transmit RF signals transmitted from the transmitter 201 in FIG. 9, and outputs the first and second received RF signals which correspond respectively to the first and second transmit RF signals. The first and second received RF signals are input to the RF reception unit 402. In the RF reception unit 402, the first and second received baseband signals are generated by converting the first and second received RF signals into a baseband frequency after they are amplified. The first and second received baseband signals are transmitted to the channel estimator 404 and the channel equalizer 403.

In the channel estimator 404, a channel response, or, in other words, a channel distortion (the distortion undergone by the transmit RF signal in the channel) is estimated by using the first and second received baseband signal. The distortion here indicates the change of received power and phase rotation. As a well-known general method of estimating channel distortion, there is a method in which the transmitter transmits a known signal (referred to as a pilot signal) predetermined between the transmitter and the receiver. Say the transmitter 201 illustrated in FIG. 2 transmits such pilot signal.

The pilot signal transmitted from the transmitter 201 is subjected to distortion on the channel 203 likewise the data signal. In the receiver 205, by comparing the transmit pilot signal and the received pilot signal, the change of received power and the phase rotation for each frequency can be estimated. The information indicative of the channel response (channel distortion) estimated in such manner is transmitted from the channel estimator 404 to the channel equalizer 403.

In the channel equalizer 403, the first and second received baseband signals output from the RF reception unit 402 are subjected to a process which suppresses channel distortion (this is called channel equalization), and the equalized first and second baseband signals are output. Among some of the known channel equalization methods, a method in which the channel distortion is suppressed by multiplying the received RF signal by an inverse characteristic of the channel response is commonly used. In other words, during transmission, in the case where the transmit RF signal has become weaker, the received RF signal is amplified, whereas, in the case where the transmit RF signal has become stronger, the received RF signal is attenuated. Meanwhile, in the case where the transmit RF signal undergoes a phase rotation during transmission, a phase rotation in an inverse direction is multiplied.

In the channel equalizer 403, the channel distortion is suppressed by the above process, and the wave pattern of the transmit RF signal is reproduced. However, since the channel estimation result has an error caused by, such as, noise, and an error caused by calculation also occurs in the channel equalization, it is difficult to reproduce the wave pattern of the transmit RF signal completely. These errors increase as the SNR of the received RF signal becomes lower. In a multipath channel, since the channel response has frequency characteristics, the extent of error differs depending on the frequency of the received RF signal. In other words, large portions and small portions of errors both exist within the spectrum of the received RF signal. This becomes the cause of error upon demodulation. The first and second equalized baseband signals output from the channel equalizer 403 are transmitted to the despreader 409. The despreader 409 will be explained later on.

The despreading code generator 405 functions likewise the spreading code generator 301 arranged in the transmitter 201 in FIG. 9. However, generally, when carrying out code spread, the spreading code and the despreading code are in complex conjugate relations. Accordingly, the complex conjugate sequence of the spreading code used in the transmitter 201 will be referred to as the despreading code hereinafter.

For example, a spreading code having a length of 12 is prepared by the despreading code generator 405, and is stored in the memory 406. The despreading code stored in the memory 406 can be read out as needed, and the contents stored in the memory 406 are kept until a new despreading code is input. A first despreading code is generated by reading out the despreading code stored in the memory 406 repeatedly, for example, seven times, at a timing provided by a timing controller 400. The first despreading code is transmitted to the reception process selector 407.

Meanwhile, by performing a computation, which is predetermined between the transmitter 201 and the receiver 205, on the first despreading code, the second despreading code is generated. In other words, in the computing unit 408, the second despreading code is generated by performing an inverse computation of the computation performed by the computing unit 303 (a computation which makes the first and second dispreading codes form a symmetric power spectrum in a frequency domain) in the transmitter 201 of FIG. 9, for example, by performing a complex conjugate computation as mentioned above.

The reception process selector 407 introduces the input first despreading code to the computing unit 408 or the despreader 409 in accordance with the instruction from the timing controller 400. The despreader 409 despreads the equalized baseband signal by multiplying and integrating the first or the second despreading code and the equalized baseband signal from the channel equalizer 403.

The despreading signal received from the despreader 409 (the despreaded baseband signal) is subjected to demodulation by the demodulator 410. The demodulation corresponds to the modulation applied by the modulator 306 within the transmitter 201 of FIG. 9. As a result, the original transmit data is reproduced by the demodulator 410.

The timing controller 400 gives processing instructions to the channel equalizer 403, the channel estimator 404, the despreading code generator 405, the memory 406 and the reception process selector 407 based on the receiving time of the first and second transmit RF signals. In other words, the timing controller 400 instructs the channel estimator 404 to perform an estimation operation at the time the pilot signal is transmitted from the transmitter 201.

The timing controller 400 gives the reception process selector 407, for example, a selection control signal of one bit, which indicates whether the received RF signal is the first received RF signal or the second received RF signal. As a result, in the case where the received RF signal is the first received RF signal, the reception process selector 407 inputs the first spreading code corresponding to the first received RF signal to the despreader 409. In the case where the received RF signal is the second received RF signal, the reception process selector 407 inputs the second spreading code corresponding to the second received RF signal to the despreader 409.

According to the present embodiment, the first transmit RF signal is generated from the first transmit baseband signal which has undergone code spreading by the first spreading code in the transmitter 201. Further, the second transmit RF signal is generated from the second transmit baseband signal which has undergone code spreading by the second spreading code forming a symmetric power spectrum with the first spreading code in the frequency domain. Consequently, it is possible to make the first and second transmit RF signals have different time waves without having to change the features of the modulator 306. Therefore, the shapes of the power spectrum of the first and second transmit RF signals can be made different. Accordingly, even if the channel 203 is a multipath channel, and the first and second transmit RF signals are caught with the same frequency selectivity on the channel 203, the influence undergone by the first and second received RF signals on the channel 203 is different from each other.

Meanwhile, in the case where the first and second received RF signals have undergone different influences on the channel 203 as mentioned above, in the receiver 205, such influence is propagated also to the equalized first and second baseband signals. Here, the first and second equalized baseband signals are modulated by the modulator 410 after they are subject to code despreading in the despreader 409 by the first and second despreading codes, which are an inverse of the first and second spreading codes in the transmitter 201.

As a result, a component which gives larger influence on either the first and second received RF signals on the channel 203 can be complemented by the other first and second received RF signals.

Accordingly, the possibility of an occurrence of reception error can be further reduced in addition to the time diversity effect, thereby improving the reception performance.

(Computing Units 303 and 408)

The computing units 303 and 408 will be explained specifically. In the computing unit 303, the second spreading code is generated by subjecting the first spreading code, which is an input, to, for example, a complex conjugate computation (a first computation). The complex conjugate computation is, for example, a computation in which a symbol of a real part (a real number component) of a complex signal, which is the input signal, is inversed, or is multiplied by −1. By subjecting the input signal to such complex conjugate computation, the signal frequency can be transferred to an axisymmetric frequency with respect to a direct current.

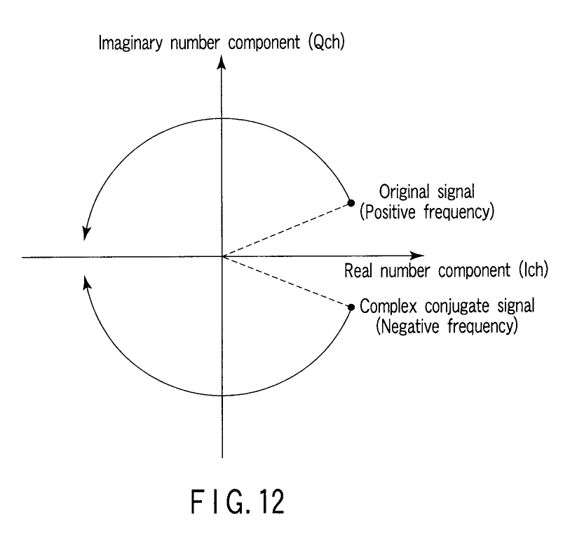

The principle is as shown in FIG. 12. For example, the signal of the positive frequency f₀, which is the input signal, is a signal rotating counterclockwise on the complex plane. When subjecting this signal to the complex conjugate computation, it is possible to generate an output signal which has the same rotation rate and has an inversed rotation direction. This means that a signal of frequency −f₀ can be generated by the complex conjugate computation.

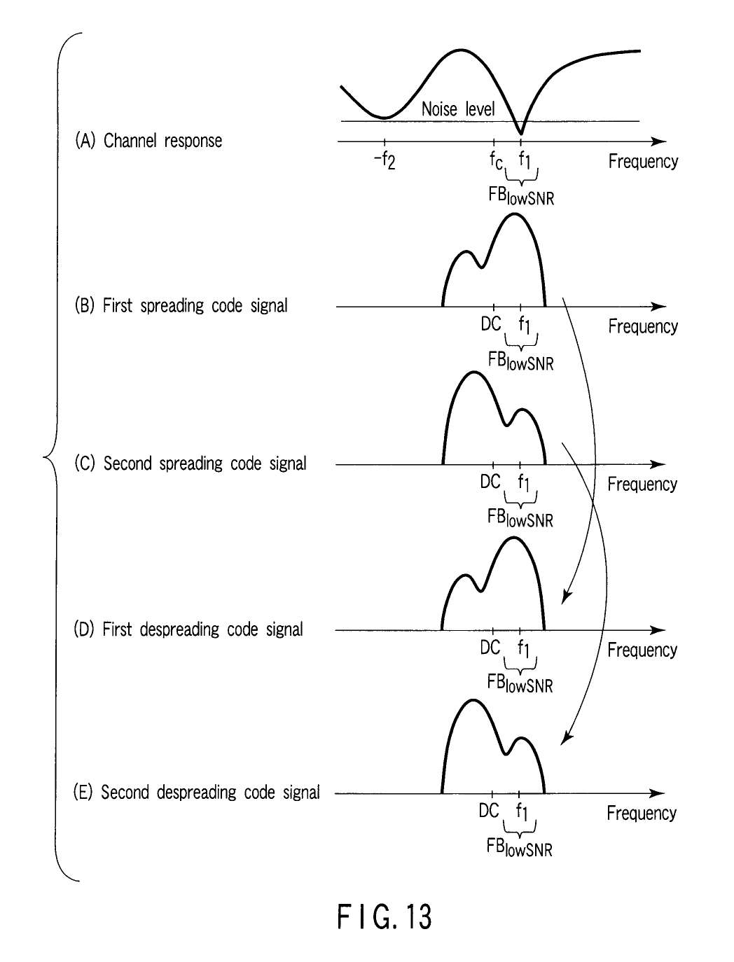

The process according to the first embodiment will be explained using FIGS. 13 (A), (B), (C), (D) and (E). The radio communication system in FIG. 1 communicates in the RF frequency. However, for convenience of explanation, in FIG. 13 (A) to (E), the frequency conversion from the baseband frequency into the RF frequency (upconvert) performed by the RF transmission unit 308, and the frequency conversion from the RF frequency into the baseband frequency (downconvert) performed by the RF reception unit 402 are omitted. Further, in the channel response of FIG. 13 (A), only the frequency band around the carrier frequency f_{c} is shown. The carrier frequency f_{c} corresponds to DC in the baseband signal. Furthermore, in FIG. 13 (A) to (E), FB_{lowSNR} represents the frequency band of the low SNR, where the received power decreases as explained in FIG. 5.

As shown in the channel response of FIG. 13 (A), it is assumed that the channel 203 has a characteristic in which the received power drops in frequencies of f_{c}+f₁ and f_{c}−f₂. In this case, the SNR of the RF signal of frequencies f_{c}+f₁ and f_{c}−f₂ (signals of frequency f₁ and −f₂ in the baseband) becomes lower. FIGS. 13 (B), (C), (D) and (E) indicate the power spectrum of each signal.

The spectrum of the first spreading code is shown in, for example, FIG. 13 (B). It is assumed that a part of the spectrum in the first transmit baseband signal includes a frequency f₁ component with low SNR. Meanwhile, the spectrum of the second spreading code obtained by subjecting the first spreading code to complex conjugate computation by the computing unit 303 is shown in, for example, FIG. 13 (C). As is obvious from FIGS. 13 (B) and (C), the first spreading code and the second spreading code form axisymmetric spectrums with respect to the frequency corresponding to DC in the frequency domain.

The first and second transmit baseband signals are transmitted respectively as the first and the second transmit RF signals from the transmitter 201 via the channel 203 at a different time. The first and second transmit RF signals are received by the receiver 205 via the channel 203 as the first and second received RF signals. These signals are despreaded by the first and second despreading codes having the spectrums shown in FIGS. 13 (D) and (E). Here, among the first and second received baseband signals, the frequency f₁ component has a low SNR since the received power attenuates on the channel 203. Accordingly, although the spectrum shape can be amended by the channel equalization process, the component in the vicinity of frequency f₁ includes a lot of errors. In the case where a part of the spectrum includes errors, an error also occurs in the time wave. Therefore, it is obvious that an error is inclined to occur at the time of demodulation.

The inverse computation of the spectrum inversion is a spectrum inversion. The inverse computation of the complex conjugate computation is the complex conjugate computation itself. In other words, the computation performed in the computing unit 408 of the receiver 205 (the second computation) is equivalent to performing the computation performed in the computing unit 303 of the transmitter 201 (the first computation) for the second time.

Among the first received baseband signals, the SNR of the frequency f₁ component is low, however, the SNR of the other frequency components is relatively high. As for the second received baseband signal, the SNR of the frequency −f₁ part is low, however, the components of the other frequencies have a relatively high SNR. Accordingly, even if the first received baseband signal is in a condition where an error is likely to occur due to the power attenuation of frequency f₁, since the SNR of frequency f₁ is relatively high in the second received baseband signal, an error becomes unlikely to occur, and the possibility of an error occurrence upon demodulation can be reduced.

In such manner, according to the first embodiment, the frequency diversity effect can be obtained by making the spectrums of the first and second spreading codes and despreading codes, which are transmitted at a different time, form a symmetry on the frequency domain. In this case, it is only necessary to add the complex conjugate computation, which is a very simple computation, and has less calculation amount and significantly lower consumption power than the method disclosed in Document 1. Particularly, in the case where the first transmit baseband signal is a digital signal, in which the most significant bit (MSB) of the digital signal indicates a polarity and the rest of the bits indicate an absolute value, the complex conjugate computation can be realized by only inversing the MSB.

Here, the complex conjugate computation has been used as the computation performed by the computing units 303 and 408. However, it does not necessarily have to be a complex conjugate computation. The complex conjugate computation is a computation which inverses the symbol of an imaginary part. However, the same result can be obtained even by inversing a symbol of a real part instead. Further, the same result is obtained when the computing unit 303 performs a computation to replace the real part with the imaginary part of the input signal. In this case, the shape of spectrum can be restored by having the computing unit 408 in the receiver 205 perform the computation to replace the real part with the imaginary part of the input signal.

### TRANSMITTER OF A SECOND EMBODIMENT

The transmitter 201 according to a second embodiment of the present invention will be explained using FIG. 14. The transmitter 201 illustrated in FIG. 14 has a transmission frequency converter 311 added to the transmitter 201 shown in FIG. 9.

The transmission frequency converter 311 converts the frequency of the spreading code output from the spreading code generator 301. Here, as an example, the spreading code is assumed as being converted into a signal of center frequency f₃. The spreading code having undergone frequency conversion is output to the memory 302. The units other than the transmission frequency converter 311 in FIG. 14 are the same as the first embodiment. Further, it is assumed that the computing unit 303 performs the complex conjugate computation. However, as mentioned earlier, it does not necessarily have to be a complex conjugate computation. Therefore, other computations mentioned in the first embodiment can also be used.

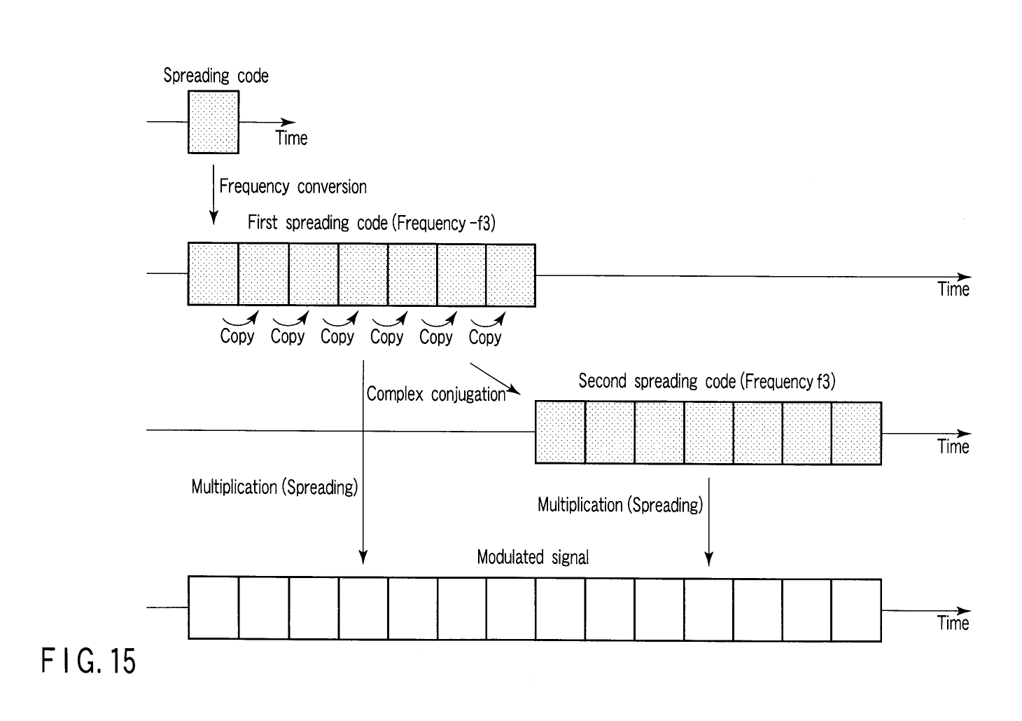

The spreading code generator 301, the memory 302, the computing unit 303, the spreader 307 and the transmission frequency converter 311 will be explained using FIG. 15. FIG. 10 illustrates the aspect up to the generation of the first transmit baseband signal which is the origin of the first transmit RF signal and the second transmit baseband signal which is the origin of the second transmit RF signal. The example of FIG. 15 shows the aspect of transmitting seven symbols each of a modulated signal respectively by the first and second transmit baseband signals, likewise in FIG. 10. Each symbol is spread by a spreading code having a length of 12.

Firstly, the spreading code in a length of 12 is prepared by the spreading code generator 301, converted into frequency −f3 by the transmission frequency converter 311, and stored in the memory 302. The readout operation from the memory 302 is repeated seven times, i.e., the spreading code is copied seven times, thereby generating a first spreading code. A part of the modulated signal (seven symbols) output from the modulator 306 is multiplied by the first spreading code, thereby subjecting the first spreading code to code spread and generating a code-spread first transmit baseband signal.

Meanwhile, the computing unit 303 performs, for example, a complex conjugate computation on the first spreading code, thereby generating a second spreading code of a frequency f3. Another part of the modulated signal (seven symbols) output from the modulator 306 is multiplied by the second spreading code, thereby subjecting the second spreading code to code spread and generating a code-spread second transmit baseband signal. In Document 2, it is necessary to perform a frequency conversion twice in total to generate the first and second spreading codes. In contrast, the present embodiment is capable of generating the first and second spreading codes by a single frequency conversion.

### RECEIVER OF THE SECOND EMBODIMENT

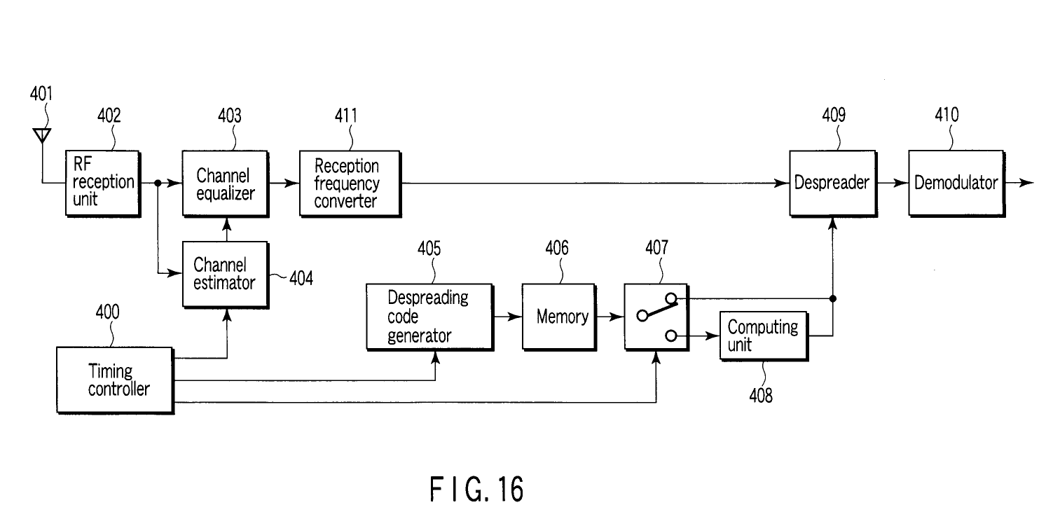

FIG. 16 shows the receiver 205 according to the second embodiment of the present invention, in which a reception frequency converter 411 is added to the receiver 205 shown in FIG. 11. The units other than the reception frequency converter 411 in FIG. 16 are the same as the first embodiment. It is assumed that the computing unit 408 performs a complex conjugate computation. However, as mentioned earlier, it does not necessarily have to be the complex conjugate computation. Therefore, other computations mentioned in the first embodiment can also be used.

In the reception frequency converter 411, a second equalized baseband signal from the channel equalizer 403 is subjected to frequency conversion to generate a converted baseband signal. The frequency conversion shifts the frequency in a certain amount (referred to as frequency shift amount) to a certain direction (referred to as frequency shift direction). The frequency shift amount in the reception frequency converter 411 is a value obtained by multiplying the frequency shift amount in the transmission frequency converter 311 of the transmitter 201 shown in FIG. 14 by a minus. In other words, the frequency shift amount in the reception frequency converter 411 is identical to the frequency shift amount in the transmission frequency converter 311, but is in the opposite frequency shift direction. For example, in the case where the frequency conversion shift in the transmission frequency converter 311 is f₃ (the frequency shift amount is f₃, and the frequency shift direction is positive), the frequency shift at the time of transmission can be compensated by setting the frequency shift in the reception frequency converter 411 as −f₃ (the frequency shift amount is f₃, and the frequency shift direction is negative).

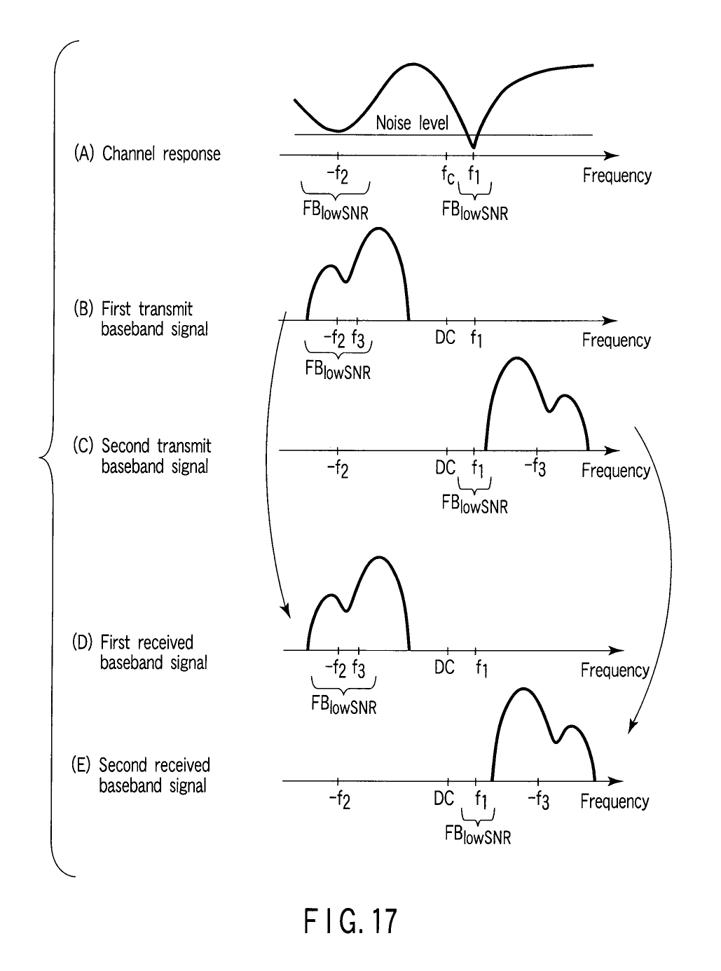

The process according to the second embodiment will be explained using FIGS. 17 (A), (B), (C), (D) and (E). Here, as explained in FIG. 13 (A) to (E), the upconvert from the baseband frequency to the RF frequency by the RF transmission unit 308 and the downconvert from the RF frequency to the baseband frequency by the RF reception unit 402 are omitted. Further, the channel response in FIG. 17 (A) only illustrates the frequency band around the carrier frequency f_{c}. The carrier frequency f_{c} corresponds to DC in the baseband signal. Furthermore, in FIG. 17 (A) to (E), FB_{lowSNR} indicates a low SNR frequency band in which the received power decreases as explained in FIG. 5.

The channel 203 is assumed to have a characteristic in which the received power drops in frequency f₁+f_{c} and frequency f_{c}−f₂ as shown in the channel response of FIG. 17 (A). In this case, the SNR of the RF signal of frequencies f_{c}+f₁ and f_{c}−f₂ (signals of frequencies f₁ and −f₂ in the baseband) decreases. FIGS. 17 (B), (C), (D) and (E) indicate the power spectrum of each baseband signal.

Since the first spreading code which code-spreads the first transmit baseband signal is subjected to the frequency conversion of frequency −f₃, as shown in FIG. 17 (B), the center frequency of the spectrum of the first transmit baseband signal is in frequency −f₃. The spectrum of the first transmit baseband signal includes a component of frequency −f₂. Meanwhile, since the second spreading code which code-spreads the second transmit baseband signal is a signal obtained by subjecting the first spreading code to the complex conjugate computation, as shown in FIG. 17 (C), the spectrum of the second transmit baseband signal is positioned in a frequency symmetric to the spectrum of the first transmit baseband signal with respect to the center DC, and has a center frequency of f₃. In this manner, the center frequency of the first transmit RF signal and the second transmit RF signal can be varied easily by using the complex conjugate computation. Thus, the frequency diversity effect can be obtained.

The first and second transmit baseband signals are transmitted respectively from the transmitter 201 as the first and second transmit RF signals at a different time via the channel 203. The first and second transmit RF signals are received as the first and second received RF signals by the receiver 205 via the channel 203. The first received baseband signal corresponding to the first received RF signal has a spectrum centering on the frequency −f₃ as shown in FIG. 17 (D). The spectrum of the first received baseband signal includes a component of frequency −f₂, which is a low SNR. Meanwhile, the second received baseband signal which corresponds to the second received RF signal has a spectrum centering on frequency f₃ as shown in FIG. 17 (E). Therefore, it does not include a component of frequency −f₂, Of low SNR, but has a relatively high SNR overall.

In this manner, according to the second embodiment, the frequency diversity effect can be obtained by simply adding a very easy computation, such as the complex conjugate computation, likewise in the first embodiment. Further, in the second embodiment, the frequencies of the first transmit RF signal and the second transmit RF signal are widely separated by combining the frequency conversions. Thus, a further effective frequency diversity effect can be obtained. Furthermore, the second embodiment requires performing a frequency conversion only on the spreading code, which becomes the origin of the first and second spreading codes, in the transmitter 201, and requires performing a frequency conversion only on the second equalized baseband signal, in the receiver 205. Accordingly, the computation amount is reduced significantly in comparison to the method of Documents 1 and 2, which require performing frequency conversions twice each in the transmitter and the receiver.

The advantages of the second embodiment will be explained in detail. According to the conventional arts, such as in Documents 1 and 2, frequency conversion must be performed twice in order to generate the first and second transmit RF signals which have different center frequencies. As mentioned earlier, since the computation amount for frequency conversion is large, the required circuit size becomes larger. Further, to perform such frequency conversion for each transmission causes an increase in consumption power. As for the receiving end, it is necessary to generate a received baseband signal by subjecting the first and second received RF signals having different center frequencies to frequency conversion in different frequency shift amounts.

Meanwhile, according to the second embodiment, the frequency conversion performed in the transmitter 201 is required only to be performed on the spreading code. The first spreading code is generated based on the spreading code, and the second spreading code can be generated by performing a complex conjugate computation on the first spreading code, for example, by performing only a simple operation such as inversing the symbol of an imaginary component. Therefore, frequency conversion need not be performed twice. The frequency conversion performed in the receiver 205 is required to be performed only on the second equalized baseband signal among the equalized baseband signals obtained from the channel equalizer 403.

(Frequency Arrangement of the Transmit RF Signal)

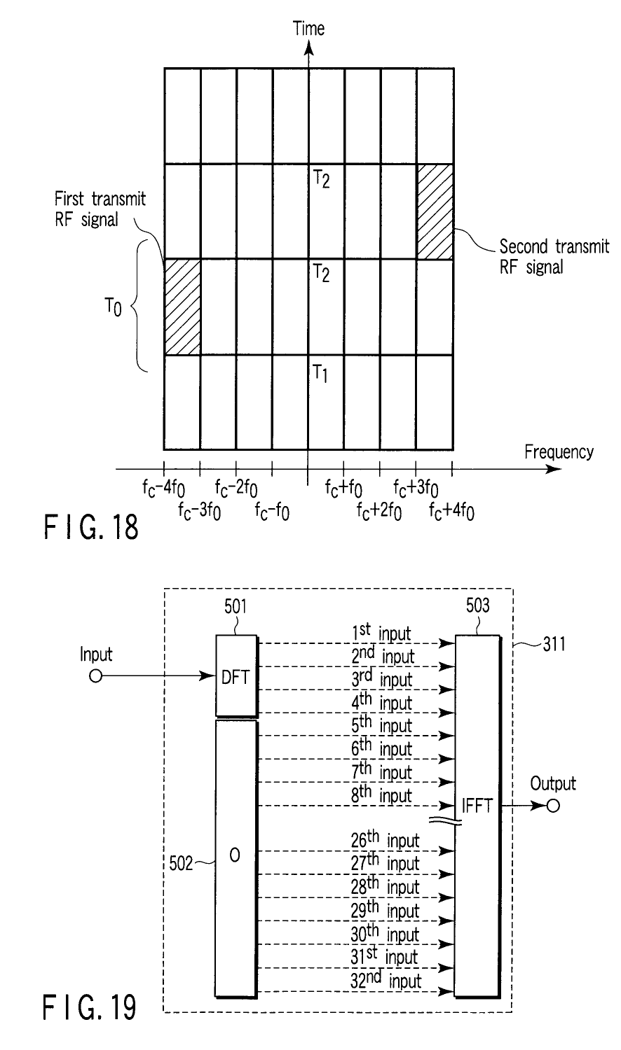

A preferred frequency arrangement of the first and second transmit RF signals will be explained with reference to FIG. 18. A transmittable frequency band of the transmitter 201 is assumed as being restricted between f_{c}−4f₀ and f_{c}+4f₀ (bandwidth is 8f₀) as shown in FIG. 18. The transmittable frequency band is divided into 8 subbands, and the bandwidth of the transmit RF signal from the transmitter 201 is assumed to be f₀. The transmission time of one transmission is assumed to be T₀.

As shown in FIG. 18, the first transmit RF signal and the second transmit RF signal are arranged on both ends of the transmittable frequency band. In other words, the center frequency of the first transmit RF signal is set as f_{c}−3.5f₀ and the center frequency of the second transmit RF signal is set as f_{c}+3.5f₀ By doing so, the frequency interval of the first transmit RF signal and the second transmit RF signal can be maximized. Thus, channel distortions undergone by the first and second transmit RF signals on the channel 203 become almost uncorrelated, thereby maximizing the frequency diversity effect.

In the example of FIG. 18, the second transmit RF signal is transmitted without a time interval after the first transmit RF signal is transmitted. However, it is also fine to transmit the second RF signal after a certain time interval from the transmission of the first transmit RF signal.

### APPLICATION EXAMPLE TO DFT-S-OFDMA

A preferred example of the transmission frequency converter 311 will be explained using FIG. 19. FIG. 19 shows a frequency conversion and sample rate conversion device used in a communication scheme referred to as DFT-s-OFDMA. DFT represents a discrete Fourier transform, s represents spread, and OFDMA represents an Orthogonal Frequency Division Multiple Access. In the case of transmitting the first and second transmit RF signals in accordance with the frequency arrangement shown in FIG. 18, upon generating the first transmit RF signal in the transmitter 201, it is necessary to generate a first spreading code which has been subjected to frequency conversion to obtain a signal of center frequency −3.5f₀ by the frequency converter 311.

In the transmission frequency converter 311 of FIG. 19, first, the spreading code from the spreading code generator 301 is input to a DFT (discrete Fourier transform) unit 501, which is a first converter. As the output of the DFT unit 501, a signal spectrum of a frequency domain is obtained. Here, as an example, the DFT size in the DFT unit 501 is four.

A first signal spectrum obtained by the DFT unit 501 has its center frequency converted by an IFFT (inverse fast Fourier transform) unit 503, which is a second converter. It is then converted into a time wave, in order to generate the first spreading code. The signal spectrum obtained by the DFT unit 501 is input to the first to fourth input ports of the IFFT unit 503, which correspond to, for example, the frequencies from −4f₀ to −3f₀. A 0 value occurrence unit 503 inputs “0” to the other fifth to the 32^{nd} input ports of the IFFT unit 503.

In other words, the IFFT size in the example of FIG. 19 is 32. Therefore, in order to have this correspond to the frequencies from −4f₀ to 4f₀, the first to the fourth input ports become the input ports corresponding to the frequencies from −4f₀ to −3f₀. When observing the output of the IFFT unit 503 by a sample rate 4f₀, the first spreading code in which the time wave is converted into a center frequency −3.5f₀ is obtained.

In the case of arranging the transmission frequency converter 311 likewise FIG. 19, the DFT unit 501 and the IFFT unit 503 need to be operated only when generating the first transmit RF signal. In contrast to Document 1, in which the DFT unit and the IFFT unit are required to be operated when generating the first and second transmit RF signals, consumption power can be reduced to almost half by operating the DFT unit 501 and the IFFT unit 503 only when generating the first transmit RF signal.

### TRANSMITTER OF A THIRD EMBODIMENT

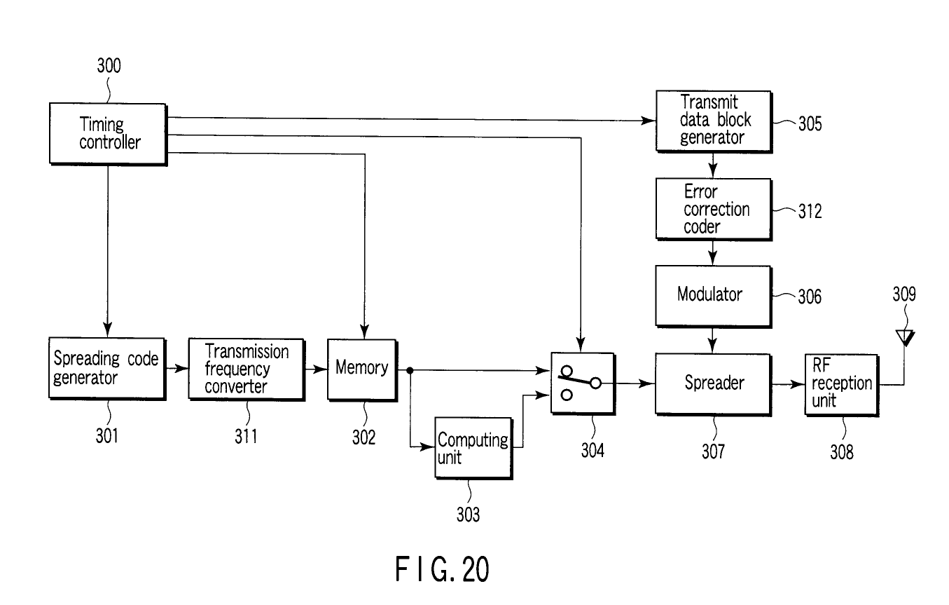

The transmitter 201 according to a third embodiment of the present invention is a transmitter which has an error correction coder 312 added to the transmitter of FIG. 14 as illustrated in FIG. 20. A transmit data block generated by the transmit data block generator 305 is modulated by the modulator 306 after being subject to error correction coding by the error correction coder 312. This enables favorable communication even under a communication path of very poor quality.

In this manner, the present embodiment reduces the possibility of degenerating both the first transmit RF signal and the second transmit RF signal by using a frequency diversity likewise the second embodiment. If either the first and second transmit RF signals can be received in favorable condition, a reception error can be restored by using the error correction function added in accordance with the present embodiment.

### TRANSMITTER OF A FOURTH EMBODIMENT

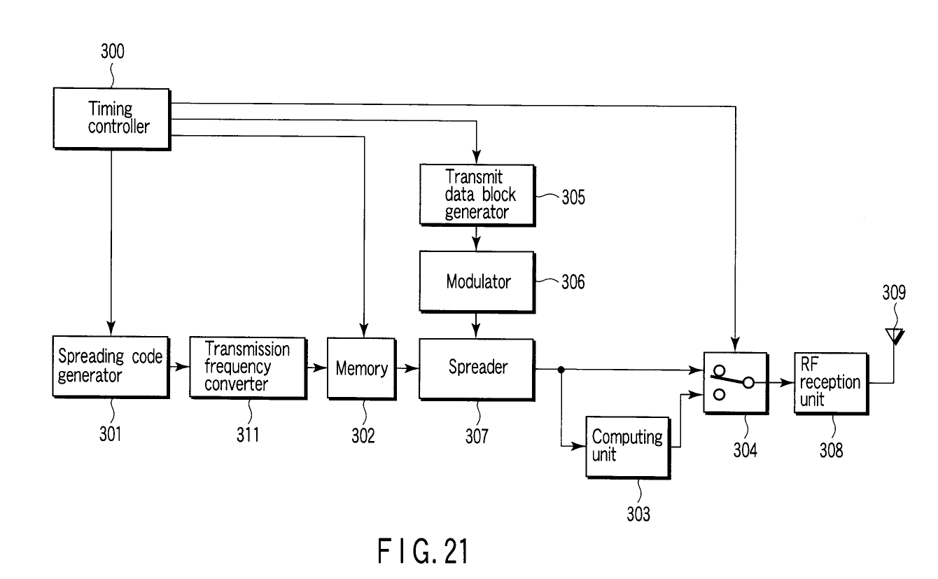

As shown in FIG. 21, the transmitter 201 according to a fourth embodiment of the present invention has the spreader 307 and the signal selector 304 switch positions from those in FIG. 14. The above configuration is also capable of realizing frequency diversity by performing the frequency conversion only once.

When an RF signal is transmitted from the transmitter 201 in which the computing unit 303 is arranged after the spreader 307 as illustrated in FIG. 21, the complex conjugate process is performed also on the modulated signal. Accordingly, when receiving the RF signal transmitted from the transmitter 201 of FIG. 21, in the receiver 205, it is necessary to perform a complex conjugate process on the second equalized baseband signal which has been despread by the modulator 410.

### RECEIVER OF A FIFTH EMBODIMENT

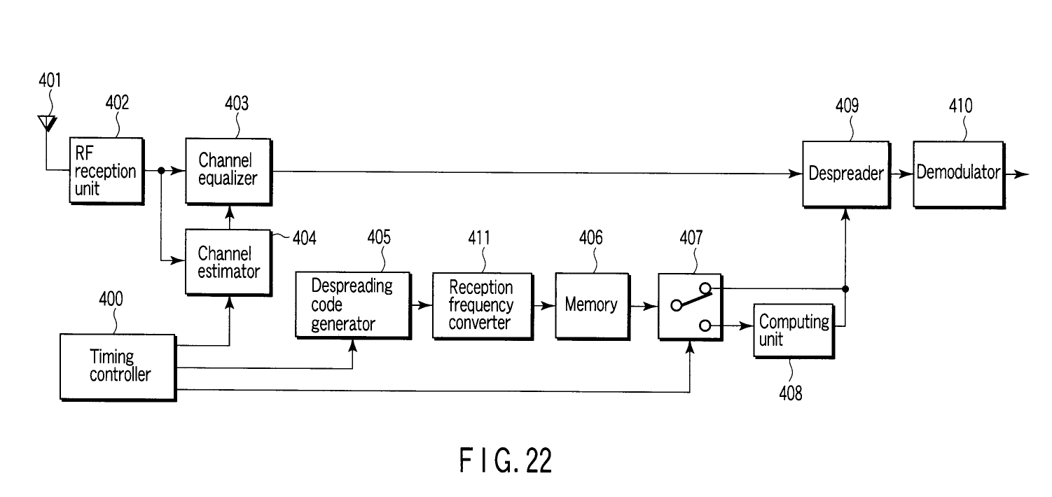

In the receiver illustrated in FIG. 16, the second equalized baseband signal was subjected to frequency conversion. However, it is also fine to subject the despreading code to frequency conversion. FIG. 22 illustrates the receiver 205 according to a fifth embodiment of the present invention, which is based on the above idea. The reception frequency converter 411 is inserted between the despreading code generator 405 and the memory 406. In the reception frequency converter 411, the despreading code positioned on DC and output from the despreading code generator 405 is converted to the frequency f3. When the above frequency conversion is performed, by despreading the first equalized baseband signal positioned on frequency −f3, the first equalized baseband signal is converted to a signal centering on DC.

Meanwhile, the despreading code stored in the memory 406 is converted into a frequency −f3 signal by the function of the computing unit 408, thereby generating the second spreading code. Therefore, by despreading the second equalized baseband signal having a center frequency f3 by using this second spread code, the second equalized baseband signal is converted likewise into a signal centering on DC.

### TRANSMITTER OF A SIXTH EMBODIMENT

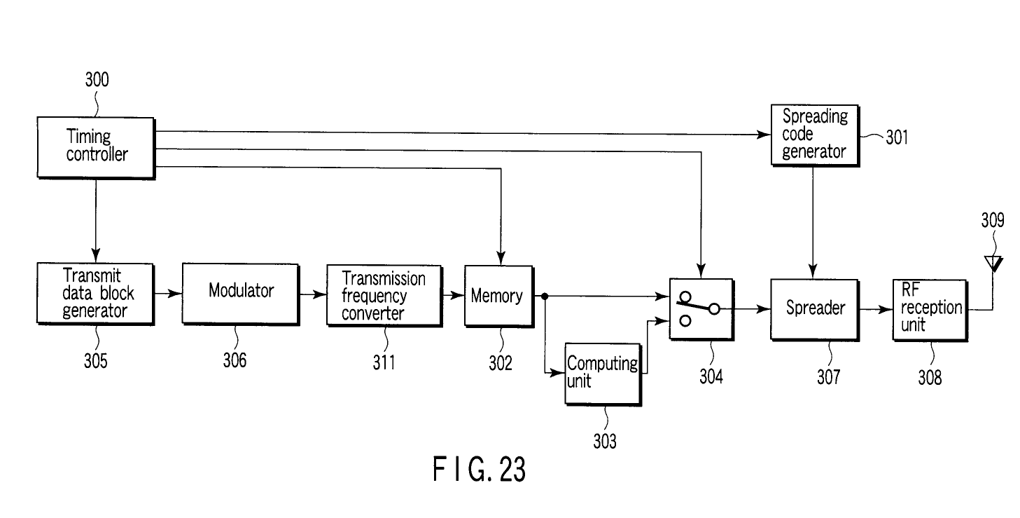

FIG. 23 shows the transmitter 201 according to a sixth embodiment of the present invention, which has the positions between the spreading code generator 301 and the transmit data block generator 305 and the modulator 306 switched from those in the transmitter 201 of FIG. 14. The configuration of the transmitter, such as, in FIG. 23 is effective in the case where, although the first spreading code and the second spreading code are different, the data transmit by the first transmit baseband signal and the data transmit by the second baseband signal are identical.

In other words, in FIG. 23, the modulated signal obtained by the process of the modulator 306 modulating the transmit block which is generated by the transmit data block generator 305 is stored in the memory 302 after being subjected to the frequency conversion by the transmission frequency converter 311. Either the first modulated signal obtained from the memory 302 and the second modulated signal obtained by the process of the computing unit 303 performing, such as, a complex conjugation on the first modulated signal is selected by the signal selector 304, and input to the spreader 307. Meanwhile, the spreading code generated by the spreading code generator 301 is given directly to the spreader 307.

Even by the above configuration, in the case where the transmit data transmitted by the first transmit baseband signal and the transmit data transmitted by the second transmit baseband signal are identical, it is possible to generate one of the first and the second transmit baseband signals from the other signal by having the computing unit 303 perform a process of, such as, complex conjugation.

### RECEIVER OF THE SIXTH EMBODIMENT

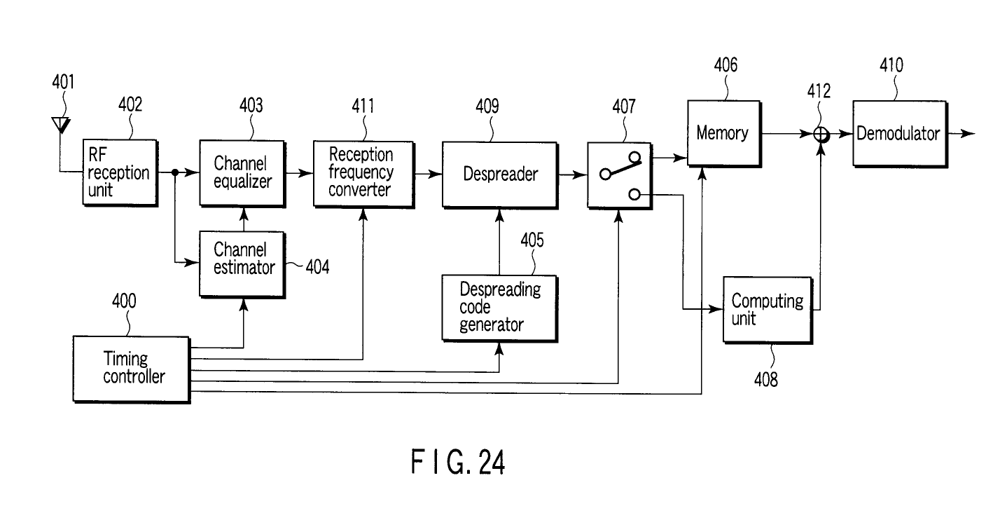

FIG. 24 illustrates the receiver 205 which corresponds to the transmitter 201 of FIG. 23. In FIG. 24, the reception process selector 407, the memory 406, the computing unit 408 and an adder 412 are arranged in between the despreader 409 and the demodulator 410 of the receiver 205 in FIG. 16. The first and second equalized baseband signals output from the channel equalizer 403 are subjected to frequency conversion into DC by the reception frequency converter 411. Further, having undergone despreading by the despreader 409, they are transmitted to the reception process selector 407. The reception process selector 407 introduces the input despreading codes to either the computing unit 408 or the memory 406, in accordance with the instruction from the timing controller 400. In the computing unit 408, the despreading code from the reception process selector 407 is subjected to an inverse computation of the computation performed by the computing unit 303 in the transmitter 201 of FIG. 23.

The signal undergone computation by the computing unit 408 is input to the adder 412. The adder 412 adds the signal read out from the memory 406 and the signal output from the computing unit 407. The output signal from the adder 412 (combined baseband signal) is demodulated by the demodulator 410, thereby reproducing the original transmit data.

(Spreading Code)

The following explains the case of using a CAZAC (Constant Amplitude and Zero Auto-Correlation) sequence for the spreading code. A CAZAC sequence refers to a sequence having a constant amplitude and a complete auto-correlation characteristic. In some cases, when applying a complex conjugate computation to one of a plurality of CAZAC sequences obtained by a certain generation method, it may become another CAZAC sequence. Details will be explained by using a Zaddof-Chu sequence which is an example of the CAZAC sequence.

The Zaddof-Chu sequence can be generated by using the following equation.

x(k)=exp(−jπnk(k+1))/N (1)

Here, n is a sequence number, k is an element number of a sequence, and N is a sequence length. There is a restriction that n cannot be a divisor of N. Accordingly, in the case of setting a prime number as N, in the Zaddof-Chu sequence of length N, k can be obtained in N ways from 0 to N−1. In the case where k=0, k=N. This is the same sequence as the case of k=0. Taking this point into consideration, in the Zaddof-Chu sequence of length N, it is known that an N−kcth sequence is completed when obtaining the complex conjugation of an arbitrary k=kcth sequence among the k=0 to k=N−1th sequence.

Accordingly, in the transmitter 201, the first spreading code and the second spreading code are considered to be generated by using the spreading code, such as the Zaqddof-Chu sequence which is converted into other sequences by obtaining a complex conjugation. In the case of using the Zaddof-Chu sequence of length N as the first spreading code and the second spreading code, the Zaddof-Chu sequence of k=kc is used as the first spreading code, and the Zaddof-Chu sequence of k=N−kc is used as the second spreading code. By applying a computation of, such as, the complex conjugation mentioned above to the first spreading code in which the Zaddof-Chu sequence of k=kc is subjected to frequency conversion, the Zaddof-Chu sequence of k=N−kc which has an inversed frequency symbol can be obtained as the second spreading code.

A sequence which is cut off somewhere along the Zaddof-Chu sequence of length N, or a sequence which repeats the Zaddof-Chu sequence of length N can be used as the spreading code. Even in such case, since the complex conjugate sequence of the k=kc sequence becomes k=N−kc, it is possible to use the k=kc Zaddof-Chu sequence as the first spreading code and the k=N−kc Zaddof-Chu sequence as the second spreading code as mentioned above.

### TRANSMITTER OF A SEVENTH EMBODIMENT

Due to the characteristic of the CAZAC sequence auto-correlation being complete, the correlation between the CAZAC sequence and the sequence obtained by a cyclic shift thereof becomes 0. Utilizing this, a case of sharing a CAZAC sequence multiplied by a different cyclic shift among a plurality of transmitters 201 can be considered.

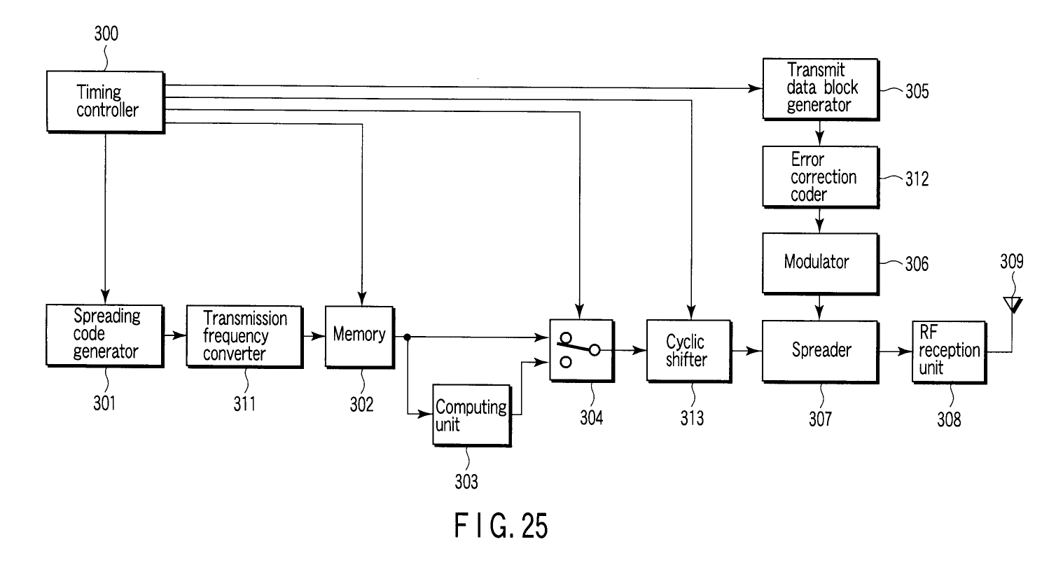

FIG. 25 illustrates the transmitter 201 provided with such cyclic shift function. It has a cyclic shifter 313 inserted between the signal selector 304 and the spreader 307 with respect to the transmitter 201 shown in FIG. 14. In the spreading code generator 301, an identical CAZAC sequence is generated among the plurality of transmitters 201. In the cyclic shifter 313, a cyclic shift is performed on the first or the second spreading signals output from the signal selector 304. The timing controller 300 gives instructions to the cyclic shifter 313 on a cyclic shift amount which is different among the transmitters. The present embodiment has the same advantage as the foregoing embodiments in that the two spreading codes having different frequencies can be generated easily by a computation of, such as, a complex conjugate process.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A radio communication method comprising:
generating a first transmit RF signal and a second transmit RF signal from a data signal to be transmitted, wherein the first transmit RF signal and the second transmit RF signal being subjected to a code spread by a first spreading code and a second spreading code, respectively forming a symmetric power spectrum in the frequency domain;
transmitting the first transmit RF signal and the second transmit RF signal from a transmit antenna at a different time;
receiving the first transmit RF signal and the second transmit RF signal to generate a first received RF signal and a second received RF signal; and
reproducing the data signal from the first received RF signal and the second received RF signal.

2. A transmission apparatus comprising:
a transmitter configured to generate a first transmit RF signal and a second transmit RF signal from a data signal to be transmitted, wherein the first transmit RF signal and the second transmit RF signal being subjected to a code spread by a first spreading code and a second spreading code, respectively forming a symmetric power spectrum in the frequency domain; and
a transmit antenna to transmit the first transmit RF signal and the second transmit RF signal.

3. The apparatus according to claim 2, wherein the first transmit RF signal and the second transmit RF signal have different center frequencies.

4. The apparatus according to claim 2, wherein the first transmit RF signal has a transmittable lowest frequency, and the second transmit RF signal has a transmittable highest frequency.

5. The apparatus according to claim 2, wherein the transmitter includes:
a spreading code generator to generate the first spreading code using a spreading code,
a computing unit configured to perform a first computation on the first spreading code to generate the second spreading code,
a modulator to modulate the data signal to generate a modulated signal,
a spreader to perform a spread process on a part of the modulated signal using the first spreading code to generate a first transmit baseband signal, and to perform a spread process on another part of the modulated signal using the second spreading code to generate a second transmit baseband signal,
an RF transmission unit configured to subject the first transmit baseband signal and the second transmit baseband signal to an RF process to generate the first transmit RF signal and the second transmit RF signal, and
a transmit antenna to transmit the first transmit RF signal and the second transmit RF signal.

6. The apparatus according to claim 5, wherein the first spreading code is a complex number signal having a real part and an imaginary part, and the computation is done by multiplying either one of the real part and the imaginary part by −1.

7. The apparatus according to claim 5, wherein the first spreading code is a complex number signal having a real part and an imaginary part, and the computation replaces the real part with the imaginary part.

8. The apparatus according to claim 2, wherein the transmitter includes:
a first frequency converter to subject a spreading code to a frequency conversion by a first frequency shift amount and in a first frequency shift direction to generate the first spreading code,
a first computing unit configured to subject the first spreading code to a first computation to generate a second spreading code which has a power spectrum forming a symmetric shape with respect to the first power spectrum in the frequency domain,
a modulator to modulate the data signal to generate a modulated signal,
a spreader to spread a part of the modulated signal using the first spreading code to generate a first transmit baseband signal, and to spread another part of the modulated signal using the second spreading code to generate a second transmit baseband signal,
an RF transmission unit configured to subject the first transmit baseband signal and the second transmit baseband signal to an RF process to generate the first transmit RF signal and the second transmit RF signal, and
a transmit antenna to transmit the first transmit RF signal and the second transmit RF signal.

9. The apparatus according to claim 8, wherein the first spreading code is a complex number signal having a real part and an imaginary part, and the first computation is a computation which multiplies either one of the real part and the imaginary part by −1.

10. The apparatus according to claim 8, wherein the first spreading code is a complex number signal having a real part and an imaginary part, and the first computation is a computation which replaces the real part with the imaginary part.

11. The apparatus according to claim 8, wherein the frequency converter comprises:
a first converter to convert the spreading code into a first signal spectrum in a frequency domain, and
a second converter to convert the center frequency of the first signal spectrum and convert it into a time wave to generate the first spreading code.

12. The apparatus according to claim 11, wherein the first converter is a DFT unit, and the second converter is an IFFT unit.

13. The apparatus according to claim 2, wherein the first spreading code and the second spreading code are generated respectively from a Zaddof-Chu sequence of sequence number k and a Zaddof-Chu sequence of sequence number N−k among Zaddof-Chu sequences of length N in which a complex conjugation sequence of a sequence of sequence number k becomes a sequence of sequence number N−k.

14. A radio receiving apparatus comprising:
a receive antenna to receive the first transmit RF signal and the second transmit RF signal transmitted from the radio transmission apparatus according to claim 5 to obtain a first received RF signal and a second received RF signal;
an RF reception unit configured to subject the first received RF signal and the second received RF signal to an RF process to generate a first received baseband signal and a second received baseband signal;
a channel equalizer to subject the first received baseband signal and the second received baseband signal to channel equalization to obtain a first equalized baseband signal and a second equalized baseband signal;
a despreading code generator to generate a first despreading code;
a second computing unit configured to perform a second computation on the first despreading code to generate a second despreading code;
a despreader to despread the first equalized baseband signal in accordance with the first despreading code, and to despread the second equalized baseband signal in accordance with the second despreading code; and
a demodulator to demodulate an output of the despreader to reproduce the data signal.

15. A radio receiving apparatus comprising:
a receive antenna to receive the first transmit RF signal and the second transmit RF signal transmitted from the radio transmission apparatus according to claim 8 to obtain a first received RF signal and a second received RF signal;
an RF reception unit configured to subject the first received RF signal and the second received RF signal to an RF process to generate a first received baseband signal and a second received baseband signal;
a channel equalizer to subject the first received baseband signal and the second received baseband signal to channel equalization to obtain a first equalized baseband signal and a second equalized baseband signal;
a frequency converter to subject the first equalized baseband signal to a frequency conversion by the first frequency shift amount and in a second frequency shift direction which is opposite to the first frequency shift direction to generate a first converted baseband signal, and to subject the second equalized baseband signal to a frequency conversion by the first frequency shift amount and in a second frequency shift direction which is equal to the first frequency shift direction to generate a second converted baseband signal;
a despreading code generator to generate a first despreading code;
a second computing unit configured to perform a second computation on the first despreading code to generate a second despreading code;
a despreader to despread the first converted baseband signal in accordance with the first despreading code, and to despread the second converted baseband signal in accordance with the second despreading code to generate a first despreading signal and a second despreading signal; and
a demodulator to demodulate the first despreading signal and the second despreading signal to reproduce the data signal.

16. A radio receiving apparatus comprising:
a receive antenna to receive the first transmit RF signal and the second transmit RF signal transmitted from the radio transmission apparatus according to claim 8 to obtain a first received RF signal and a second received RF signal;
an RF reception unit configured to subject the first received RF signal and the second received RF signal to an RF process to generate a first received baseband signal and a second received baseband signal;
a channel equalizer to subject the first received baseband signal and the second received baseband signal to channel equalization to obtain a first equalized baseband signal and a second equalized baseband signal;
a despreading code generator to generate a despreading code;
a frequency converter to subject the despreading code to a frequency conversion by the first frequency shift amount and in a second frequency shift direction which is opposite to the first frequency shift direction to generate a first despreading code;
a second computing unit configured to perform a second computation on the first despreading code to generate a third despreading code;
a despreader to despread the first equalized baseband signal in accordance with the first despreading code, and to despread the second equalized baseband signal in accordance with the second despreading code to generate a first despreading signal and a second despreading signal; and
a demodulator to demodulate the first despreading signal and the second despreading signal to reproduce the data signal.

17. The apparatus according to claim 14, wherein the first spreading code and the second spreading code are generated respectively from a Zaddof-Chu sequence of sequence number k and a Zaddof-Chu sequence of sequence number N−k among Zaddof-Chu sequences of length N in which a complex conjugation sequence of a sequence of sequence number k becomes a sequence of sequence number N−k.

18. The apparatus according to claim 15, wherein the first spreading code and the second spreading code are generated respectively from a Zaddof-Chu sequence of sequence number k and a Zaddof-Chu sequence of sequence number N−k among Zaddof-Chu sequences of length N in which a complex conjugation sequence of a sequence of sequence number k becomes a sequence of sequence number N−k.

19. The apparatus according to claim 16, wherein the first spreading code and the second spreading code are generated respectively from a Zaddof-Chu sequence of sequence number k and a Zaddof-Chu sequence of sequence number N−k among Zaddof-Chu sequences of length N in which a complex conjugation sequence of a sequence of sequence number k becomes a sequence of sequence number N−k.
